(19) United States
(12) Patent Application Publication
(10) Pub. No.: US 2020/0318227 A1
(43) Pub. Date: Oct. 8, 2020

(54) LASER CLEANING PRIOR TO METALLIC COATING OF A SUBSTRATE

(71) Applicant: United Technologies Corporation, Farmington, CT (US)

(72) Inventors: Henry H. Thayer, Wethersfield, CT (US); Bartolomeo Palmieri, Guilford, CT (US); Dmitri Novikov, Avon, CT (US)

(73) Assignee: United Technologies Corporation, Farmington, CT (US)

(21) Appl. No.: 16/375,147

(22) Filed: Apr. 4, 2019

(51) Int. Cl. C23C 4/02; C23C 4/134; C23C 4/073; B08B 7/00

(52) U.S. Cl. CPC C23C 4/02; B08B 7/0042; C23C 4/073; C23C 4/134

(57) ABSTRACT

A method for treating a substrate prior to metallic coating includes the steps of providing a substrate having a surface to be coated and at least one contaminant selected from as-delivered organics and post-burn out oxides on the surface; treating the surface with a laser to remove the at least one contaminant to produce a cleaned surface on the substrate; and applying a metallic coating to the cleaned surface. Grit blasting can be avoided, and reverse arc transfer cleaning is avoided or minimized, resulting in time savings and less stress on the substrate.

### BACKGROUND OF THE DISCLOSURE

The present disclosure relates to a metallic coating method and, more particularly, to a coating method utilizing a laser cleaning before the metallic coating.

Gas turbine engine components such as air foils in high pressure turbines, combustor panels or liners and the like are exposed to extreme temperatures and conditions during use, and are therefore provided with metallic coatings during manufacture. Prior to metallic coating of a substrate, contaminants such as oils and other organics, as well as oxides, must be removed from the surface to be coated.

Following known methods, a substrate is first run through a furnace to burn off the oils and organics, a step referred to as “burn out”, and then abrasive blasting (grit blasting) is used to remove the remaining and/or resulting oxides. The grit used can be aluminum oxide (Al₂O₃), although other abrasives can also be used. Finally, a reverse transfer arc (RTA) step can be used to strip out the last remaining oxides prior to coating.

In such a process, one drawback is that there are always two steps involved, namely burn out and grit blast, both of which are time consuming. In addition, the grit blast does not always remove all oxides, and the grit blast process itself can embed some of the grit into the substrate. This embedded grit is difficult to remove, and can result in more time and higher power in the RTA process. Such a process is illustrated in FIG. 3 which is discussed below.

The need remains for a coating method wherein the as-furnished part can be treated simply and effectively in a way which reduces the number of steps, and reduces the time and power needed for any RTA steps.

### SUMMARY

A method for treating a substrate prior to metallic coating comprises the steps of: providing a substrate having a surface to be coated and at least one contaminant selected from as-delivered organics and post-burn out oxides on the surface; treating the surface with a laser to remove the at least one contaminant to produce a cleaned surface on the substrate; and applying a metallic coating to the cleaned surface.

In a non-limiting configuration, the metallic coating is applied by low pressure plasma spray.

In another non-limiting configuration, the contaminant is the as-delivered organics, and the treating step comprises applying the laser to the as-delivered organics to produce the cleaned surface.

In a further non-limiting configuration, the contaminant is post-burn out oxides produced by heat treating the as-delivered organics, and the treating step comprises applying the laser to the post-burn out oxides to produce the cleaned surface.

In a still further non-limiting configuration, the contaminant is both as-delivered organics and oxides.

In another non-limiting configuration, the method further comprises the step of reverse transfer arc (RTA) treating the surface after the treating step to remove any remaining contaminants and produce the cleaned surface.

In a further non-limiting configuration, the RTA treating step is carried out for a period of time of less than 3 minutes and at a current of less than 20 amps.

In another non-limiting configuration, the metallic coating is NiCoCrAlY coating.

In a further non-limiting configuration, the surface comprises a single crystal alloy material.

In another non-limiting configuration, the treating step comprises applying a laser at a laser spot size of between 0.700 and 2.4 mm in diameter, power between 500 and 1,000 W, pulse duration of between 50 and 100 ns, pulse overlap of between 40 and 60%, and energy pulse of between 30 and 100 mJ.

In a further non-limiting configuration, the laser treatment step comprises pulsing a nanosecond laser at up to 1 kW per pulse, at a pulse diameter of about 1.5 mm.

In another non-limiting configuration, the substrate is selected from the group consisting of HPT airfoils, combustor panels and combustor liners.

The foregoing features and elements may be combined in various combinations without exclusivity, unless expressly indicated otherwise. These features and elements as well as the operation of the invention will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a perspective view of a turbine blade.

FIG. 2 is a cross-sectional view of the turbine blade of FIG. 1 where a section has been taken at line 2-2 (shown in FIG. 1) and shows a TBC system overlying the airfoil of the turbine blade.

FIG. 3 is a prior art process for cleaning the substrate before coating.

FIG. 4 shows a process according to one non-limiting configuration of the present disclosure.

### DETAILED DESCRIPTION

The invention relates to a method for cleaning an as-delivered surface of a component before coating that surface with a metallic coating such as a NiCoCrAlY coating. Numerous components of gas turbine engines and the like can be coated in this manner, and the present non-limiting disclosure is made in terms of coating a turbine blade.

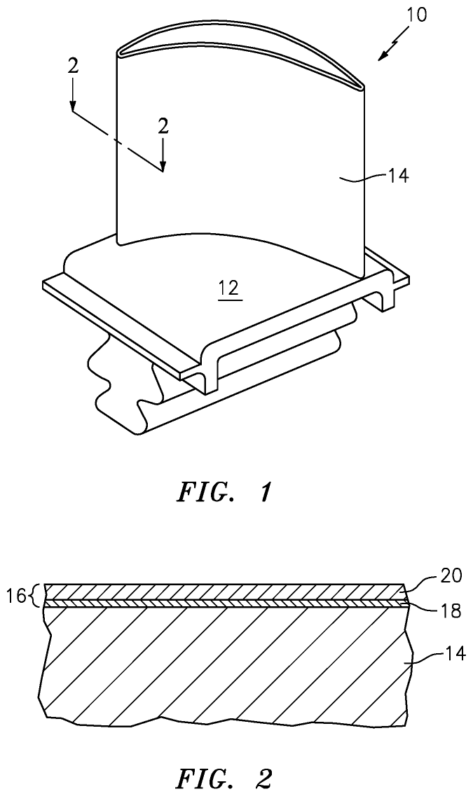

FIG. 1 is a perspective view of turbine blade 10 of a gas turbine engine, as one example of a component to be treated as disclosed herein. Turbine blade 10 includes platform 12 and airfoil 14. Airfoil 14 of turbine blade 10 may be formed of a nickel based, cobalt based, iron based superalloy, or mixtures thereof or a titanium alloy. Turbine blade 10 is exposed to high temperatures and high pressures during operation of the gas turbine engine. In order to extend the life of turbine blade 10 and protect it from high stress operating conditions and the potential for oxidation and corrosion, one or more metallic coating(s) 16, 18, 20 can be applied over airfoil 14 and platform 12 of turbine blade 10.

The exact placement of the metallic coating depends on many factors, including the type of turbine blade 10 employed and the areas of turbine blade 10 exposed to the most stressful conditions. For example, in alternate embodiments, a metallic coating may be applied over a part of the outer surface of airfoil 14 rather than over the entire surface of airfoil 14. Airfoil 14 may include cooling holes leading from internal cooling passages to the outer surface of airfoil 14, and the coating 16 may also be applied in other locations as well.

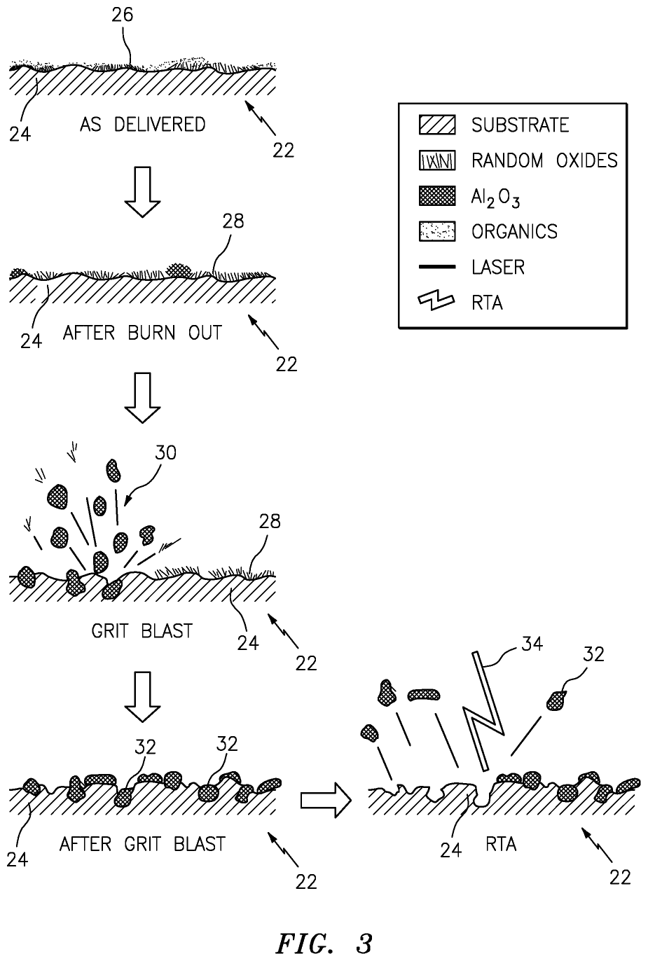

FIG. 2 is a sectional view of turbine blade 10, where a section is taken from line 2-2 in FIG. 1. The coating system 16 is applied to an exterior surface of airfoil 14 and platform 12.

FIG. 3 shows a schematic illustration of a known process for cleaning a substrate before metallic coating. As shown, a substrate 22 has a surface 24 with as-delivered contaminants 26 in the form of oils, organics, oxides and other materials which must be removed before a desired metallic coating can be applied to surface 24. In the known process, the part is then subjected to burn out, and this results in substrate 22 having surface 24 with random oxides 28 thereon. These oxides 28 can be remaining from the contaminants 26, or can have resulted from the burn out step. Following the known process, surface 24 is then treated with a grit blast process, wherein particles of grit 30 are directed against surface 24 to remove the oxides 28. As shown particles of grit do remove most or even all of the random oxides 28, but also result in some particles 32 embedded into surface 24. These particles 32 must themselves now be removed, and so the next step following the known process is a reverse transfer arc (RTA) treatment step wherein RTA treatment 34 is applied to surface 24 to remove particles 32 and any other remaining contaminants 26.

The process shown in FIG. 3 calls for many time-consuming steps. Further, RTA treatment is a harsh and energy and time consuming process. The harsh conditions and stresses to which the component surface is exposed can have an adverse impact on the overall quality of the substrate.

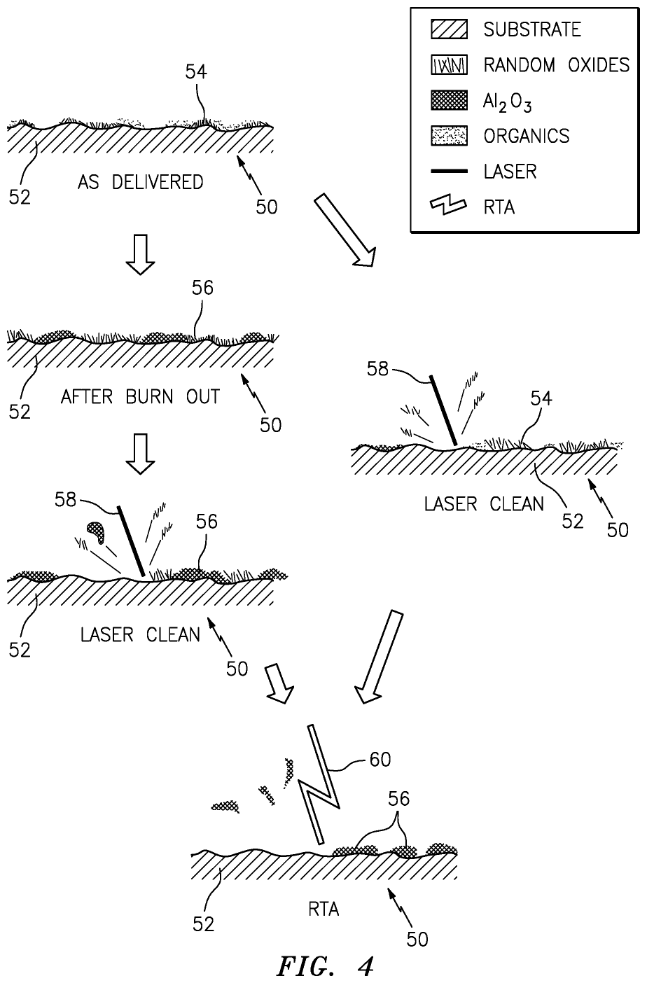

FIG. 4 shows two non-limiting configurations of a process wherein laser cleaning is utilized to avoid some of the steps from FIG. 3, as well as avoiding the undesirable affects of those steps. As shown, a substrate 50 is delivered having a surface 52 and as-delivered contaminants 54 on surface 52.

It should be appreciated that the as-delivered contaminants 54 can include organics which can be a result of the manufacturing process and also from handling and the like, as well a variety of oxides, all of which are to be removed before coating the substrate. With the known approach of FIG. 3, the burn out step would convert some organics and other materials to oxides, and then the oxides, which would be a combination of remaining oxides from the as-delivered substrate and newly developed oxides from the burn out step, would need to be removed.

In one configuration as disclosed herein, substrate 50 is subjected to a heat treatment to burn off contaminants 54 and leave random oxides 56. Then, surface 52 with random oxides 56 can then be treated with a laser 58 to remove the random oxides 56 and produce a cleaned surface for metallic coating, without the need for grit blasting and, therefore, also without the need for removing embedded grit particles.

Following treatment with laser 58, if any oxides or other contaminants remain, an RTA treatment 60 can still be conducted. It should be appreciated, however, that this since there has been no grit blast, there is no embedded grit in the surface. Therefore, the RTA step can be conducted at a lower power and intensity, and for a shorter time, as compared to the RTA conducted in the method of FIG. 3. Typical RTA parameters can reach a current of nearly 50 amps at an extreme end, and can take as long as 8 minutes. With the presently disclosed process, the RTA step if needed will not exceed 3 minutes in duration, and current will not exceed 20 amps. This results in a significantly reduced stress on the part or component being cleaned for metallic coating.

Alternatively, and still referring to FIG. 4, laser 58 can be used to directly remove as-delivered organics 54, without any burn out step. This can be done, for example, where there are no areas masked from the laser which might otherwise require burn out to clean. As with the laser cleaning conducted after burn out, RTA cleaning 60 can be performed if necessary, again at a lower intensity and time duration than would otherwise be needed.

In one non-limiting configuration, the component to be treated can be a component of a gas turbine engine, such as HPT vanes or blades, combustor panels or liners and the like. Further, these components are treated as-delivered from casting, and have not yet been coated with other coating systems. The surfaces of such components will have what is referred to herein is as-delivered contaminants, which are typically hydrocarbons or other organics that can result from the manufacturing process and handling after such manufacture. Beneath these contaminants, the substrate will be a single crystal casting which, once cleaned, is then ready for metallic coating.

The metallic coating to be applied can be a NiCoCrAlY coating, as one non-limiting example. Other types of metallic coating could follow the laser cleaning as disclosed herein. Examples include any other material which will be applied using LPPS, or a variety of materials which may be applied using different processes such as cathodic arc coating, high velocity oxygen fuel (HVOF) coating, cold spray, flame spray and the like. Any coating process which requires a clean, smooth surface can benefit from the method disclosed herein. Within this broad application, however, one particularly useful application of the method is prior to coating using LPPS to apply a NiCoCrAlY coating.

Laser treatment as disclosed herein can be conducted using a range of different parameters which can be combined to produce the desired clean smooth surface. These parameters include laser spot size of between 0.700 and 2.4 mm in diameter, power between 500 and 1,000 W, pulse duration of between 50 and 100 ns, pulse overlap of between 40 and 60%, and energy pulse of between 30 and 100 mJ. Within these ranges, it is particularly useful to apply laser by pulsing a nanosecond laser at up to 1 kW per pulse, at a pulse diameter of about 1.5 mm.

When burn out is needed to burn as-delivered contaminants, for example when the part or component has cavities which trap liquids, the contaminants are typically converted to random oxides, the most prominent of which include aluminum oxides in many different forms or phases, as well as chromium oxides, and nickel oxides. Other metals in the substrate can also oxidize and thus may also be present before cleaning. Laser treatment as disclosed herein can quickly remove these oxides without creating a different contaminant (for example, embedded grit), that needs to be removed. Further, the waste stream from laser treatment is minimal, potentially involving only a fume collector.

It should also be appreciated that the grit blast cleaning used in the known process can roughen the surface of the substrate which can be undesirable. Replacing this step with laser treatment as disclosed herein results in a smoother surface and, therefore, a smoother metallic coating.

Although a combination of features is shown in the illustrated examples, not all of these features need to be combined to realize the benefits of various embodiments of this disclosure. In other words, a method according to an embodiment of this disclosure will not necessarily include all of the features shown in any one of the figures or all of the steps or details schematically shown in the figures. Moreover, selected features of one example embodiment may be combined with selected features of other embodiments.

It should be understood that like reference numerals identify corresponding or similar elements throughout the several drawings. It should also be understood that although a particular component, an airfoil, is illustrated in FIG. 1, other components can be coated following the present method.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A method for treating a substrate prior to metallic coating, comprising the steps of:
providing a substrate having a surface to be coated and at least one contaminant selected from as-delivered organics and post-burn out oxides on the surface;
treating the surface with a laser to remove the at least one contaminant to produce a cleaned surface on the substrate; and
applying a metallic coating to the cleaned surface.

2. The method of claim 1, wherein the metallic coating is applied by low pressure plasma spray.

3. The method of claim 1, wherein the contaminant is the as-delivered organics, and wherein the treating step comprises applying the laser to the as-delivered organics to produce the cleaned surface.

4. The method of claim 1, wherein the contaminant is post-burn out oxides produced by heat treating the as-delivered organics, and wherein the treating step comprises applying the laser to the post-burn out oxides to produce the cleaned surface.

5. The method of claim 1, wherein the contaminant is both as-delivered organics and oxides, and wherein the treating step removes the organics and the oxides from the surface.

6. The method of claim 1, further comprising the step of reverse transfer arc (RTA) treating the surface after the treating step to remove any remaining contaminants and produce the cleaned surface.

7. The method of claim 6, wherein the RTA treating step is carried out for a period of time of less than 3 minutes and at a current of less than 20 amps.

8. The method of claim 1, wherein the metallic coating is NiCoCrAlY coating.

9. The method of claim 1, wherein the surface comprises a single crystal alloy material.

10. The method of claim 1, wherein the treating step comprises applying a laser at a laser spot size of between 0.700 and 2.4 mm in diameter, power between 500 and 1,000 W, pulse duration of between 50 and 100 ns, pulse overlap of between 40 and 60%, and energy pulse of between 30 and 100 mJ.

11. The method of claim 1, wherein the laser treatment step comprises pulsing a nanosecond laser at up to 1 kW per pulse, at a pulse diameter of about 1.5 mm.

12. The method of claim 1, wherein the substrate is selected from the group consisting of HPT airfoils, combustor panels and combustor liners.
